(19) United States
(12) Patent Application Publication
(10) Pub. No.: US 2025/0044427 A1
(43) Pub. Date: Feb. 6, 2025

(54) DISTANCE MEASURING APPARATUS, METHOD FOR CONTROLLING DISTANCE MEASURING APPARATUS, AND METHOD FOR PROCESSING DATA

(71) Applicant: Panasonic Intellectual Property Management Co., Ltd., Osaka (JP)

(72) Inventors: YASUHISA INADA, Osaka (JP); AKIRA HASHIYA, Osaka (JP); YUMIKO KATO, Osaka (JP)

(21) Appl. No.: 18/919,484

(22) Filed: Oct. 18, 2024

Related U.S. Application Data
(63) Continuation of application No. PCT/JP2023/003707, filed on Feb. 6, 2023.

(30) Foreign Application Priority Data
May 13, 2022 (JP) 2022-079311

(51) Int. Cl. G01S 7/4911; G01S 7/48; G01S 7/481; G01S 7/4914; G01S 17/42; G01S 17/89

(52) U.S. Cl. CPC G01S 7/4911; G01S 7/4808; G01S 7/4813; G01S 7/4817; G01S 7/4914; G01S 17/42; G01S 17/89

(57) ABSTRACT

A distance measuring apparatus includes a light source that emits a light beam, a scanning device that performs beam scanning where an emission direction of the light beam is changed, a photodetector that receives light reflected from measurement points on a target irradiated with the light beam and that outputs detection signals, a processing circuit that calculates distances to the measurement points on a basis of the detection signals, and a control circuit that controls the scanning device. The control circuit determines a step angle of the beam scanning in such a way as to reduce differences in density of the measurement points between areas of the target.

### BACKGROUND

### 1. Technical Field

The present disclosure relates to a distance measuring apparatus, a method for controlling a distance measuring apparatus, and a method for processing data.

### 2. Description of the Related Art

3D measurement is performed using a sensor capable of measuring distances in order to obtain information regarding a three-dimensional shape of a structure. When a relatively large product such as a vehicle, an apparatus, or a home appliance is manufactured in a factory, for example, 3D measurement is sometime performed in order to inspect a state such as a shape, dents, or concaves and convexes on a surface. Process control can be performed by performing 3D measurement on a part or a work in progress and evaluating a shape or bruises. In a construction site, too, 3D measurement information is obtained, and progress control and quality control can be performed on the basis of the data in a necessary scene in a construction process. For example, automatic marking can be performed by performing 3D measurement on a construction site and marking necessary positions using a projector or the like. Even when there are no drawings at a time of extension or renovation of a building, drawings can be produced by obtaining information regarding a 3D shape using a sensor. Furthermore, when a refractory material is sprayed or concrete joint surface treatment is performed in a construction process, process control can be performed, without visual inspection, by measuring and inspecting the shape using a sensor.

Japanese Unexamined Patent Application Publication No. 11-336017 and Japanese Unexamined Patent Application Publication No. 2010-156622 disclose examples of a system for obtaining information regarding a surface shape of a structure. Japanese Unexamined Patent Application Publication No. 11-336017 discloses a surface processing shape evaluation system that calculates feature values of a processing shape of a surface of existing concrete using a distance measuring apparatus such as a laser rangefinder, ultrasonic rangefinder, or the like. Japanese Unexamined Patent Application Publication No. 2010-156622 discloses a method for scanning a still steel plate with polarized laser light, obtaining data regarding a detected point cloud on the steel plate, and measuring a shape of the steel plate from the data regarding the detected point cloud. In the method disclosed in Japanese Unexamined Patent Application Publication No. 2010-156622, thinning processing for equalizing density of points in the detected point cloud and arithmetic processing for analyzing a regression curve from the data regarding the detected point cloud are performed.

### SUMMARY

One non-limiting and exemplary embodiment provides a technique for improving accuracy of 3D measurement.

In one general aspect, the techniques disclosed here feature a distance measuring apparatus including a light source that emits a light beam, a scanning device that performs beam scanning where an emission direction of the light beam is changed, a photodetector that receives light reflected from measurement points on a target irradiated with the light beam and that outputs detection signals, a processing circuit that calculates distances to the measurement points on a basis of the detection signals, and a control circuit that controls the scanning device. The control circuit determines a step angle of the beam scanning in such a way as to reduce differences in density of the measurement points between areas of the target.

According to the embodiment of the present disclosure, accuracy of 3D measurement can be improved.

It should be noted that general or specific aspects of the present disclosure may be implemented as a system, an apparatus, a method, an integrated circuit, a computer program, a computer-readable storage medium, or any selective combination thereof. The computer-readable storage medium may include a nonvolatile storage medium or a nonvolatile storage medium such as a compact disc read-only memory (CD-ROM). The apparatus may include one or more apparatuses. When the apparatus includes two or more apparatuses, the two or more apparatuses may be arranged in one device, or may be arranged separately in two or more discrete devices. In the present specification and the claims, an “apparatus” can refer to not only a single apparatus but also a system including a plurality of apparatuses.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a diagram schematically illustrating a distance measuring apparatus according to an exemplary embodiment of the present disclosure;

FIG. 1B is a diagram illustrating another example of configuration of the distance measuring apparatus;

FIG. 2 is a block diagram illustrating an example of the configuration of the distance measuring apparatus;

FIG. 3A is a diagram schematically illustrating an example of distribution of measurement points in a case where beam scanning is performed at a constant step angle;

FIG. 3B is a diagram schematically illustrating an example of distribution of measurement points in a case where beam scanning where a step angle is corrected in accordance with an emission direction;

FIG. 4 is a flowchart illustrating an example of a measurement procedure performed by the distance measuring apparatus;

FIG. 5A is a diagram schematically illustrating a relationship between a reference plane in an evaluation area including concaves and convexes, an arithmetic mean height, and a root mean square height;

FIG. 5B is a diagram schematically illustrating an example of a reference plane of concaves and convexes including a low-period swell;

FIG. 5C is a diagram schematically illustrating another example of the reference plane of concaves and convexes including a low-period swell;

FIG. 6 is a flowchart illustrating an example of a procedure of distance measurement in a case where pre-measurement is performed;

FIG. 7 is a diagram schematically illustrating how distances are measured while moving the distance measuring apparatus;

FIG. 8 is a diagram illustrating a method for making density of measurement more uniform through data processing;

FIG. 9A is a diagram illustrating size of a structure;

FIG. 9B is another diagram illustrating size of a structure;

FIG. 10A is a diagram illustrating an example where the density of measurement points is insufficient for structure size;

FIG. 10B is a diagram illustrating an example where the density of measurement points is appropriate for structure size;

FIG. 10C is a diagram illustrating an example where the density of measurement points is excessive for structure size;

FIG. 11 is a block diagram illustrating an example of configuration of a light detection and ranging (LiDAR) sensor; and

FIG. 12 is a diagram illustrating an example of temporal changes in frequency of reference light, reflected light, and interference light in a case where a distance between the LiDAR sensor and a target is constant.

### DETAILED DESCRIPTIONS

Embodiments that will be described hereinafter are general or specific examples. Values, shapes, materials, components, arrangement positions and connection modes of the components, steps, order of the steps, and the like mentioned in the following embodiments are examples, and not intended to limit the technology in the present disclosure. Among the components in the following embodiments, those not described in the independent claims, which define broadest concepts, will be described as optional components. The drawings are schematic diagrams, and not necessarily strict illustrations. In the drawings, essentially the same or similar components are given the same reference numerals. Redundant description might be omitted or simplified.

In the present disclosure, a subset or all of circuits, units, apparatuses, members, or parts, or a subset or all of function blocks in block diagrams, can be achieved, for example, by one or a plurality of electronic circuits including a semiconductor device, a semiconductor integrated circuit (IC), or a large-scale integration (LSI) circuit. The LSI circuit or the IC may be integrated on a single chip or achieved by combining a plurality of chips together. For example, function blocks other than storage elements may be integrated on a single chip. Although a term “LSI circuit” or “IC” is used here, the term used changes depending on a degree of integration, and a device called a “system LSI circuit”, a “very-large-scale integration (VLSI) circuit”, or a “ultra-large-scale integration (ULSI) circuit” may be used, instead. A field-programmable gate array (FPGA), which is programmed after an LSI circuit is fabricated, or a reconfigurable logic device, in which connection relationships can be reconfigured and circuit sections can be set up inside an LSI circuit, can also be used for the same purposes.

Furthermore, a subset or all of functions of the circuits, the units, the apparatuses, the members, or the parts can be achieved through software processing. In this case, software is stored in one or more non-transitory storage media such as a read-only memory (ROM), an optical disc, or a hard disk drive, and a processor or a peripheral device executes the functions specified by the software when the processor executes the software. A system or an apparatus may include one or a plurality of non-transitory storage media storing the software, processors, and necessary hardware devices, such as interfaces.

In the present disclosure, “light” refers to electromagnetic waves including not only visible light (a wavelength of about 400 nm to about 700 nm) but also ultraviolet light (a wavelength of about 10 nm to about 400 nm) and infrared light (a wavelength of about 700 nm to about 1 mm).

### Underlying Knowledge Forming Basis of Present Disclosure

Before describing the embodiments of the present disclosure, underlying knowledge forming the basis of the present disclosure will be described.

As sensors capable of performing 3D measurement on a structure, various sensors including contact sensors, imaging sensors, and light detection and ranging (LiDAR) sensors are used.

With a method in which a contact sensor is used, it takes time to measure a surface shape, and there is a problem that it is difficult to perform 3D measurement on a large structure in a short period of time.

As a measurement method based on imaging, there is a method in which a parallax of a subject is measured using a stereo camera including two cameras and information regarding a 3D shape is obtained on the basis of the parallax. In the method in which the stereo camera is used, matching processing for obtaining a parallax from two images needs to be performed. It is difficult, however, to accurately measure a surface shape for a flat surface without feature points or a surface having a fine random pattern.

A LIDAR sensor measures distances using a light beam such as laser. For example, 3D measurement can be performed by measuring distances while performing a scanning operation where an emission direction of the light beam is changed. Since such a LiDAR sensor uses a collimated or focused light beam, energy of light is focused on a radiation point. Distances, therefore, can be accurately measured even for a far target. Because sampling needs to be performed during beam scanning in order to perform the 3D measurement, on the other hand, the measurement takes time, which is disadvantageous. When a target does not move during beam scanning or movement of a target is sufficiently slow relative to movement of beam scanning, therefore, it can be said that 3D measurement based on LiDAR is one of optimal methods.

In addition to LiDAR, there are several other methods in which a target is scanned with a light beam for radiating the target. In a method disclosed in Japanese Unexamined Patent Application Publication No. 11-336017, for example, scanning is performed by moving a measuring instrument that emits a fixed beam. If a trajectory of the movement of the measuring instrument is not accurately grasped, however, it is difficult to accurately obtain information regarding a 3D shape of a target. A mechanism for moving the measuring instrument is also necessary, which undesirably makes the configuration complex.

In a LiDAR sensor that performs a scanning operation, an emission angle of a laser beam is changed by rotating a mirror or a prism using an electric motor or using a beam scanning mechanism such as micro-electromechanical systems (MEMS) mirror. In general, a driving operation in beam scanning and a sampling rate of measurement of distances using a laser beam are determined in advance when a product is designed. In many cases, specifications of a LiDAR sensor are determined in such a way as to achieve a step angle with which measurement points are arranged at substantially regular intervals.

According to an examination conducted by the inventors, the following problem arises when 3D measurement of a target is performed using such a LiDAR sensor. Density of measurement points changes in accordance with an angle of incidence of a beam on a target in a viewing angle of measurement. More specifically, the density of measurement points decreases when the beam is obliquely incident than when the beam is incident near-vertically. If the density of measurement points varies in measurement data regarding a target, a problem might occur when a result of measurement is analyzed. For example, when an outline of a target is obtained through fitting on the basis of results of 3D measurement, the fitting is affected by results of the 3D measurement in portions where measurement points are dense, and errors in portions where the density of measurement points is low become large. In addition, when a surface area or surface roughness is evaluated on the basis of the results of the 3D measurement, evaluation values are affected by the density of measurement points (i.e., the number of measurement points in unit area or unit length). It becomes difficult, therefore, to evaluate relative changes between measurement areas.

Japanese Unexamined Patent Application Publication No. 2010-156622 discloses a method for detecting a swell in a shape of a steel plate by thinning point cloud data obtained through scanning based on laser light, equalizing the density of measurement points, and obtaining a regression surface. This method is effective when a microscopic shape such as a swell is analyzed, because the density of measurement points need not be high in this case.

When a complex shape is measured or a surface is evaluated in terms of surface area or roughness, however, a certain degree of density of measurement points or higher is required. Measurement with an unnecessarily high density of measurement points, therefore, needs to be performed depending on a position, which can increase measurement time and a load of data processing.

On the basis of the above examination, the present inventors have arrived at a configuration according to an embodiment that will be described hereinafter. An exemplary embodiment of the present disclosure will be described hereinafter in detail with reference to the accompanying drawings. Unnecessarily detailed description, however, might be omitted. For example, detailed description of well-known matters and redundant description of essentially the same configuration might be omitted. This is in order to prevent the following description from becoming unnecessarily redundant and help those skilled in the art better understand the present disclosure. The inventors provide the accompanying drawings and the following description to help those skilled in the art to sufficiently understand the present disclosure, and do not intend to limit the subject matter described in the claims with the drawings and the description.

### EMBODIMENT

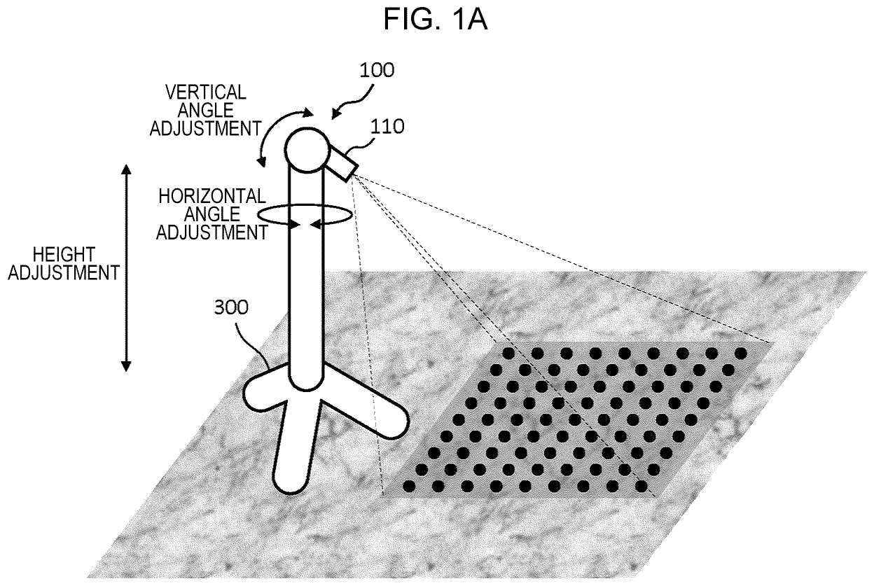

FIG. 1A is a diagram schematically illustrating a distance measuring apparatus 100 according to the exemplary embodiment of the present disclosure. The distance measuring apparatus 100 illustrated in FIG. 1A measures distances to a plurality of measurement points on a target while performing a scanning operation where an emission direction of a light beam is changed. The distance measuring apparatus 100 is capable of generating three-dimensional point cloud data on the basis of the distances to the measurement points. The three-dimensional point cloud data includes data regarding three-dimensional coordinate values of each of the plurality of measurement points and represents three-dimensional distribution of the plurality of measurement points. 3D measurement of a target can be performed using the distance measuring apparatus 100.

The distance measuring apparatus 100 can be installed on the ground or a floor of a building using a support 300 such as a tripod. In the example illustrated in FIG. 1A, a measurement target is a floor. The target may be a structure made of any material and may be, for example, the ground, a floor, or a concrete surface. The target is not limited to a flat structure, and may be, for example, the ground whose surface is not flat, a wall of a building, an industrial product, or another structure, instead.

The distance measuring apparatus 100 includes a beam scanning mechanism and is capable of changing the direction of the light beam emitted from a beam emitter 110. The 3D measurement can be performed by scanning, with the light beam, an area in a field of view in a direction in which the beam emitter 110 faces. FIG. 1A illustrates the field of view, which is a scanning range, with four broken lines. Solid circles in FIG. 1A indicate an example of the measurement points.

The distance measuring apparatus 100 illustrated in FIG. 1A is capable of adjusting height, a horizontal angle, and a vertical angle of the beam emitter 110. The height of the beam emitter 110 is a height from an installation surface of the distance measuring apparatus 100. The horizontal angle is a rotational angle about an axis perpendicular to the installation surface relative to a reference direction. The vertical angle is a rotational angle about an axis parallel to the installation surface relative to a vertically downward direction. The height, the horizontal angle, and the vertical angle of the beam emitter 110 may be fixed at a time of the installation or adjusted and fixed by the user before measurement. The height of the beam emitter 110 can be set to an appropriate height according to the target, such as 50 cm, 1 m, or 2 m. The horizontal angle and the vertical angle are set such that the beam emitter 110 faces a measurement target area of the target. A mechanism for adjusting the height, the horizontal angle, and the vertical angle of the beam emitter 110 need not be mounted on the distance measuring apparatus 100.

FIG. 1B is a diagram illustrating another example of the configuration of the distance measuring apparatus 100. As illustrated in FIG. 1B, a support 300 like a scaffold may support the distance measuring apparatus 100, instead. With this configuration, measurement can be performed with the distance measuring apparatus 100 directly facing (i.e., a vertical angle of) 0° a surface of a target.

The distance measuring apparatus 100 can include a light source such as a laser, an optical system such as a lens, a photodetector, and a scanning device. The scanning device changes the direction of the light beam emitted from the light source. The distance measuring apparatus 100 can also include a control circuit that controls the scanning device and a processing circuit that processes a signal output from the photodetector. The control circuit controls the scanning device to change a horizontal component and a vertical component of the emission direction of the light beam emitted from the beam emitter 110. As a result, as indicated by solid circles in FIGS. 1A and 1B, a plurality of measurement points arranged in two dimensions is sequentially irradiated with the light beam. The scanning device may be configured in such a way as to change only the horizontal component or the vertical component of the emission direction of the light beam. In this case, one-dimensional scanning can be performed. The processing circuit calculates a distance to each measurement point on the basis of a detection signal generated by the photodetector in response to light reflected from the measurement point. As a method for measuring a distance, for example, a known distance measuring technique such as time of flight (ToF) or frequency-modulation continuous wave (FMCW) can be used. As a result of beam scanning, distance data for the plurality of measurement points can be generated. Three-dimensional coordinate data, that is, point cloud data, regarding the plurality of measurement points can then be generated from the distance data for the plurality of measurement points.

When the distance measuring apparatus 100 is used to measure distances to measurement points one by one while performing beam scanning, an angle of incidence of the light beam on a target changes in the field of view, and accordingly density of measurement points in unit area or unit length changes. As a result, unevenness is caused in spatial density of point cloud data, which is a result of the measurement of the target.

In the present embodiment, therefore, variation in the density of measurement points is suppressed by adjusting a step angle of the beam scanning in accordance with the emission direction and removing data for some measurement points in an area where the density is unnecessarily high from obtained point cloud data. As a result, the density of measurement points can be made more uniform. By making the density of measurement points more uniform, spatial unevenness in accuracy of extracting a 3D shape of a target can be reduced. In addition, when a rough surface with a fine pattern or random irregularities is evaluated, a decrease in reliability of a result of measurement due to variation in the density of measurement points can be suppressed.

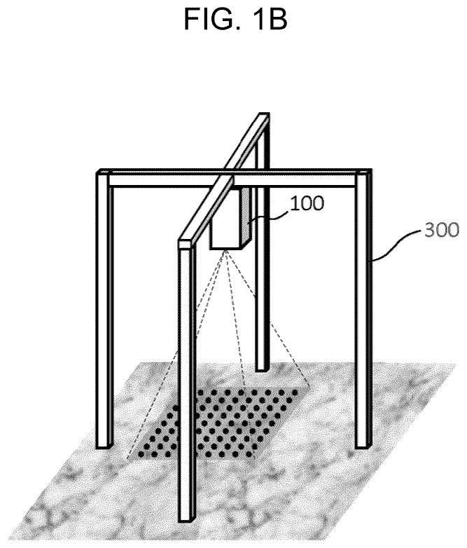

FIG. 2 is a block diagram illustrating an example of configuration of the distance measuring apparatus 100 according to the present embodiment. In FIG. 2, thick arrows indicate a flow of light, and thin arrows indicate a flow of signals. The distance measuring apparatus 100 illustrated in FIG. 2 includes the beam emitter 110, a light source 120, a scanning device 130, a photodetector 140, a processing circuit 150, a control circuit 160, a storage device 170, an input interface 180, and an output interface 190. The beam emitter 110 is a part of the distance measuring apparatus 100 that emits a light beam and can include an optical system, such as a lens, therein.

The light source 120 includes a light emission element that emits light, such as a laser or a light-emitting diode (LED). The light source 120 can be configured to emit a light beam in a wavelength range of, for example, infrared light or visible light.

The scanning device 130 includes a beam scanning mechanism such as a combination of an electric motor and a mirror, a MEMS mirror, or a phased array. The scanning device 130 performs beam scanning where the emission direction of the light beam is changed.

The photodetector 140 receives light reflected from measurement points on a target irradiated with the light beam and outputs detection signals. The photodetector 140 includes one or more light receiving elements. Each light receiving element performs photoelectric conversion and outputs an electrical signal according to intensity of received light. The photodetector 140 outputs, to the processing circuit 150, a detection signal based on an electrical signal output from each light receiving element. The photodetector 140 may include an image sensor. The image sensor has a structure where a plurality of light receiving elements is arranged in a two-dimensional plane. The image sensor outputs image signals as detection signals.

The processing circuit 150 calculates a distance to each measurement point on the basis of a detection signal. The processing circuit 150 can include one or more processors such as a central processing unit (CPU), a field-programmable gate array (FPGA), and/or a graphics processing unit (GPU). The processing circuit 150 calculates the distance using a distance measuring technique such as ToF or FMCW. When FMCW is used, the photodetector 140 can be configured to not directly detect light reflected from a target but detect interference light between emitted light and reflected light. An example of configuration of a distance measuring apparatus that employs FMCW will be described later.

The control circuit 160 controls the amount of light emitted from the light source 120 and the scanning operation performed by the scanning device 130. The control circuit 160 can be achieved by a circuit including one or more processors and one or more memories such as an FPGA and/or a microcontroller unit (MCU). The control circuit 160 and the processing circuit 150 may be achieved by a single integrated circuit, instead. The control circuit 160 and the processing circuit 150 may each be provided for an apparatus other than the distance measuring apparatus 100, instead. A processor in a computer connected to the distance measuring apparatus 100, for example, may function as at least one of the control circuit 160 and the processing circuit 150. In this case, the control circuit 160 or the processing circuit 150 is configured to communicate with the distance measuring apparatus 100 through wired or wireless communication.

The storage device 170 is any storage device such as a semiconductor storage device, a magnetic storage device, or an optical storage device. The storage device 170 stores computer programs executed by the control circuit 160 and the processing circuit 150 and various pieces of data generated in the course of processes performed by these circuits.

The input interface 180 is an interface for inputting signals from external apparatuses. The output interface 190 is an interface for outputting signals to external apparatuses.

The control circuit 160 according to the present embodiment determines the step angle of the beam scanning (hereinafter also referred to as a “spatial scanning step”) in such a way as to reduce differences in the density of measurement points between areas of a target. The “step angle” refers to an angle between an emission direction of a light beam toward a measurement point and an emission direction of a light beam toward a next measurement point. The control circuit 160 can reduce differences in the density of measurement points between areas of a target by, for example, changing the step angle of the beam scanning in accordance with the emission direction of the light beam. Alternatively, the control circuit 160 can reduce differences in the density of measurement points between areas of a target by changing the step angle in accordance with a distance between the beam emitter 110 (or the light source 120) and the target. The control circuit 160 may obtain information indicating the distance from the storage device 170 and change the step angle on the basis of the information. For example, the control circuit 160 may reduce the step angle as the distance becomes larger. When a target is provided on the surface on which the distance measuring apparatus 100 is installed, the height of the beam emitter 110 (or the light source 120) corresponds to the distance. An example of operation of the control circuit 160 will be described in detail hereinafter.

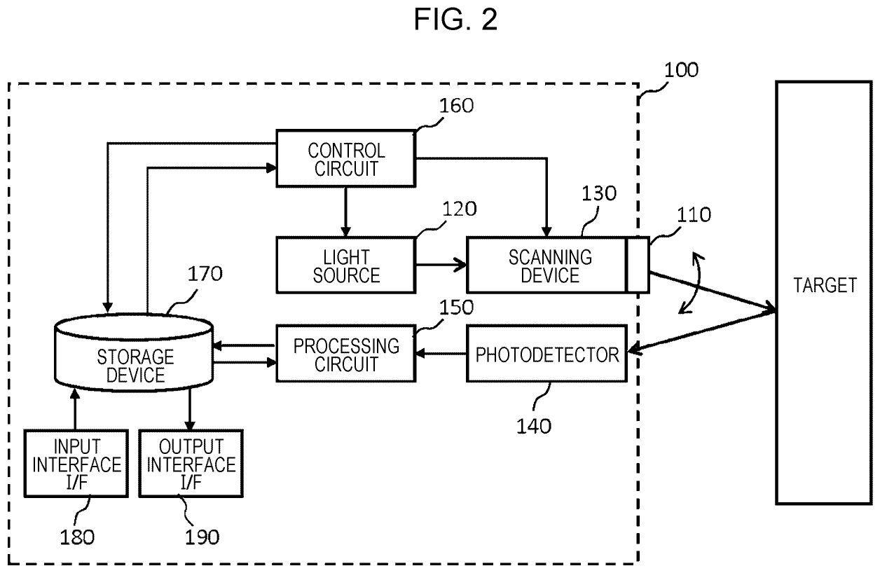

FIG. 3A is a diagram schematically illustrating an example of distribution of measurement points at a time when the beam scanning is performed with a constant step angle. FIG. 3B is a diagram schematically illustrating an example of a case where distribution of measurement points is made uniform by performing the beam scanning while correcting the step angle in accordance with the emission direction. In FIGS. 3A and 3B, an X-axis, a Y-axis, and a Z-axis that are perpendicular to one another are illustrated. The X-axis and the Y-axis are set in the installation surface of the distance measuring apparatus 100. The Z-axis is perpendicular to the installation surface and set with a vertically upward direction defined as a positive direction. In FIGS. 3A and 3B, a solid circle on the Z-axis indicates a position of the beam emitter 110. Point cloud data can be, for example, data of three-dimensional coordinate values of each measurement point represented in an XYZ coordinate system illustrated in FIGS. 3A and 3B,

When a mechanism for rotating a mirror at a constant speed using an electrical motor is used as the beam scanning mechanism and the measurement points are measured one by one at a constant sampling rate, for example, the measurement points are obtained with a constant step angle. At this time, if a target with a flat surface is measured through the beam scanning, for example, the density of measurement points varies depending on a measured area as illustrated in FIG. 3A. When a vertical angle of the emission direction of the beam is denoted by θ, the density of surrounding points becomes cosθ times lower than in the case of vertical incident (0=) 0°. When the scanning is performed with movement that is not performed at a constant speed using a resonant mirror, a MEMS mirror, or the like as the beam scanning mechanism, too, the density of measurement points generally becomes low in an area where the radiation angle θ is large and high in an area where the radiation angle θ is small.

The density of measurement points also changes depending on height h of the beam emitter 110, which is a point from which the beam is emitted. When the height is doubled, for example, the density of measurement points becomes four times lower insofar as the same scanning operation is performed.

When parameters of an installation angle and the height of the beam emitter 110 are fixed values, or when a jig or a sensor can measure or set the parameters, distribution of the density of measurement points can be predicted from the values of the parameters. It is therefore effective to adjust a beam scanning operation or a measurement rate and correct the spatial scanning step in accordance with the predicted density of measurement points.

More specifically, the control circuit 160 can make the density of measurement points in the field of view even more uniform by slowing the beam scanning in accordance with a decrease in the density of measurement points due to an increase in the radiation angle θ while fixing the measurement rate, that is, the number of times of emission of the beam in unit time. Alternatively, the control circuit 160 may increase the measurement rate in accordance with a decrease in the density of measurement points due to an increase in the radiation angle θ while fixing speed of the beam scanning. Alternatively, the control circuit 160 may make the density of measurement points more uniform by adjusting both the speed of the beam scanning and the measurement rate. Through these operations, the density of measurement points can be made more uniform as illustrated in FIG. 3B.

When a surface of a target is substantially flat, the control circuit 160 may make adjustments in such a way as to increase the density of measurement points by a factor of 1/cosθ in accordance with the radiation angle θ of the light beam. When the height of the beam emitter 110 is denoted by h and the user desires to achieve the same density of measurement points as when measurement was performed in the past with a height h1, the control circuit 160 may change the step angle of the beam scanning such that the density of measurement points is multiplied by (h1/h)². When distances are measured in a one-dimensional area by performing the beam scanning in one-dimensional direction, too, the control circuit 160 may change the step angle of the beam scanning in accordance with the radiation angle θ or the height h1.

When a surface of a target is not flat and the target is a structure with a highly uneven surface, it is difficult to completely correct the density of measurement points through the above-described correction. Unevenness in the density, however, is reduced compared to when no correction is performed, and some effect can be produced.

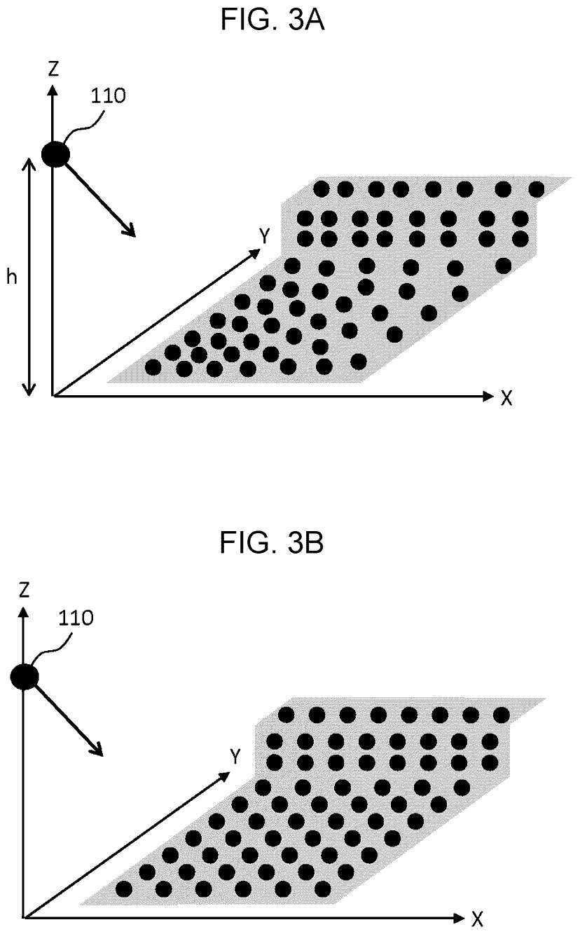

FIG. 4 is a flowchart illustrating an example of a measurement procedure performed by the distance measuring apparatus 100. First, in step S101, the distance measuring apparatus 100 is installed at a position where it is appropriate to measure a distance to a target. When the target is a floor as illustrated in FIG. 1A, for example, the distance measuring apparatus 100 is installed near a part of the floor whose shape is to be evaluated.

Next, in step S102, the horizontal angle, the vertical angle, and the height of the beam emitter 110 are adjusted. An operator who performs a measurement operation, for example, may perform the adjustment. After completing the adjustment, the operator may input information such as the angles and the height using an input device. Alternatively, the apparatus may automatically read the angles and the height and input the information. The input information is stored in the storage device 170 through the input interface 180. These pieces of data will be used in later steps S103 and S107. The distance measuring apparatus 100 may include one or more sensors that measure the horizontal angle, the vertical angles, and the height of the beam emitter 110. In this case, information regarding the horizontal angle, the vertical angle, and the height measured by the sensors can be stored in the storage device 170.

In step S103, the control circuit 160 determines, on the basis of the input or measured horizontal angle, vertical angle, and height, the step angle of the scanning in such a way as to achieve a certain density of measurement points. The control circuit 160 changes the step angle of the scanning in accordance with the emission direction of the light beam such that, for example, the step angle of the scanning decreases as an angle from a direction of vertically incident light increases. Next, in step S104, the control circuit 160 controls the scanning device 130 in accordance with the determined step angle to perform the 3D measurement. During the 3D measurement, the processing circuit 150 calculates a distance to a measurement point each time the beam emitter 110 emits a light beam. During the measurement, information indicating that the measurement is being performed or remaining time of the measurement may be displayed on a display of a personal computer (PC), a mobile computer, or the like connected to the distance measuring apparatus 100.

After the measurement ends, in step S106, the processing circuit 150 saves measurement data including distance information for each measurement point to the storage device 170 or a storage device of the PC, the mobile computer, or the like connected to the distance measuring apparatus 100.

In the next step S107, the processing circuit 150 converts the measurement data into three-dimensional point cloud data in a certain coordinate system. The certain coordinate system can be, for example, the XYZ coordinate system illustrated in FIGS. 3A and 3B. Because an origin is an emission point of the beam in the measurement data, coordinate conversion is performed as necessary. The data regarding the horizontal angle, the vertical angle, and the height of the beam emitter 110 input in step S102 is used for the coordinate conversion.

In a next step S108, the processing circuit 150 extracts, as necessary, data in an area of the obtained data to be analyzed. An object other than the target might be included in the field of view of the distance measuring apparatus 100. In this case, the operator can specify a part of the field of view as a target of a shape analysis using the PC or the mobile computer. The processing circuit 150 extracts the data in the specified area to be analyzed. This area will be referred to as an “evaluation area” in the following description.

In step S109, the processing circuit 150 analyzes the shape from point cloud data in the extracted evaluation area. For example, a surface shape may be extracted or surface roughness may be evaluated through fitting based on distribution of measurement points. The surface roughness can be evaluated using, for example, a roughness parameter, which will be described later.

In step S110, the processing circuit 150 outputs information (e.g., the roughness parameter etc.) indicating a result of the analysis to the storage device 170 or an external display device. The processing circuit 150 may thus generate and output information indicating surface roughness in an area including a plurality of measurement points on a target on the basis of distance information for the plurality of measurement points. In step S110, the processing circuit 150 may determine whether a surface state of the target satisfies a desired condition by comparing the calculated roughness parameter or the like with a predetermined threshold. When a surface of a target needs to be rough, the desired condition is a case where the roughness parameter is larger than the certain threshold. When a surface of a target must not be rough, that is, needs to be smooth, the desired condition is a case where the roughness parameter is smaller than the certain threshold. When a surface of a target needs to be moderately rough, the desired condition is a case where the roughness parameter falls within a certain range.

As a result of the above operations, unevenness in the density of measurement points in each area of the target can be suppressed, and the surface shape of the target can be accurately evaluated.

### Example of Roughness Parameter

Next, an example of the roughness parameter in the evaluation area calculated in step S109 will be described. The evaluation area may be a two-dimensional area or may be a one-dimensional area. Size of the evaluation area can be determined, for example, in accordance with dimensions of convexes and concaves on a surface of a target.

First, a method for calculating the roughness parameter when the evaluation area is a two-dimensional area will be described. The evaluation area can be, for example, a rectangular, circular, or elliptical two-dimensional area. Such an evaluation area is effective for a surface of a target with concaves and convexes distributed in two dimensions.

An example of the roughness parameter is an arithmetic mean height Sa. The arithmetic mean height Sa is calculated from the following expression (1).

$${S}_{a} = \frac{1}{A} {\int }_{A} \vert Z ( x , y ) \vert dxdy \qquad ( 1 )$$

Z (x, y) denotes a difference in the height of a concave or a convex from a reference plane Z=0 at a position X=x and Y=y in the evaluation area. The reference plane is a plane at an average height of concaves and convexes in the evaluation area. “A” in expression (1) denotes area of the evaluation area. The arithmetic mean height Sa is a value obtained by averaging, in the evaluation area, absolute values of differences in the height of the concaves and the convexes from the reference plane Z=0. The height of the concaves and the convexes can be obtained from the distance information for the plurality of measurement points.

A root mean square height Sq, which is another example of the roughness parameter, is obtained from the following expression (2).

$${S}_{q} = \sqrt{\frac{1}{A} {\int }_{A} {Z}^{2} ( x , y ) dxdy} \qquad ( 2 )$$

The root mean square height Sq is obtained as a square root of an average of squares of the differences in the height of the concaves and the convexes from the reference plane Z=0 in the evaluation area. The root mean square height Sq corresponds to a standard deviation of the differences in height in the evaluation area and indicates variation in the differences in height. The root mean square height Sq and the arithmetic mean height Sa satisfy Sq≥Sa. Sq/Sa deviates from 1 more significantly as the variation in the differences in height increases.

Other examples of the roughness parameter include a developed interfacial area ratio Sdr, which is an index of surface area, skewness Ssk, which indicates symmetry of distribution of the height of concaves and convexes, kurtosis Sku, which indicates the tailedness of distribution of the height of concaves and convexes, and a root-mean-square slope Sdq, which indicates steepness of concaves and convexes.

As described above, the roughness parameter can be, for example, one selected from the group consisting of the arithmetic mean height Sa, the root mean square height Sq, the developed interfacial area ratio Sdr, the skewness Ssk, the kurtosis Sku, and the root-mean-square slope Sdq in a two-dimensional area.

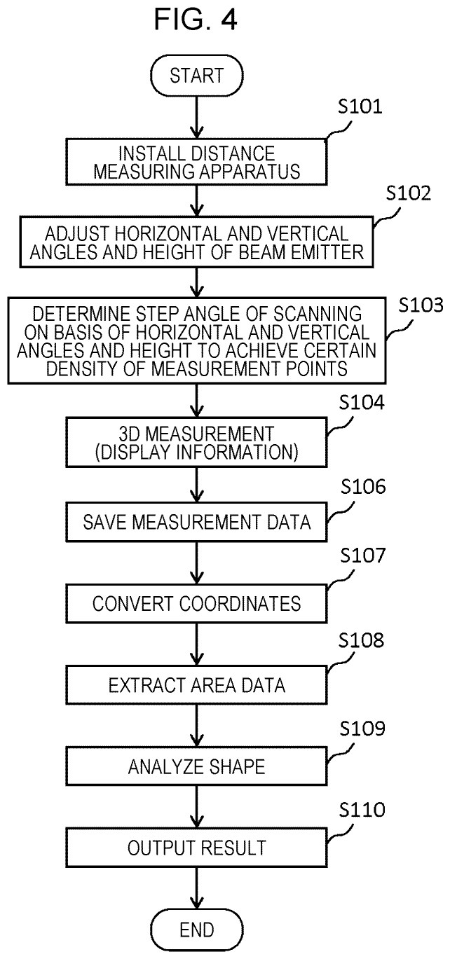

Next, an example of the arithmetic mean height Sa and the root mean square height Sq and an example of the reference plane in the evaluation area with concaves and convexes will be described with reference to FIGS. 5A and 5C. FIG. 5A is a diagram schematically illustrating a relationship between the reference plane Z=0, the arithmetic mean height Sa, and the root mean square height Sq in the evaluation area with concaves and convexes. A broken line in FIG. 5A represents the reference plane, and solid lines represent the arithmetic mean height Sa and the root mean square height Sq. In the example illustrated in FIG. 5A, Sq/Sa>1, and there is some degree of variation in differences in the height of concaves and convexes from the reference plane Z=0.

When the concaves and the convexes do not include a swell as illustrated in FIG. 5A, the reference plane Z=0 is a flat plane. When the concaves and the convexes include a low-period swell, on the other hand, the reference plane may be defined as follows. FIGS. 5B and 5C are diagrams schematically illustrating examples of the reference plane for concaves and convexes including a low-period swell. In the example illustrated in FIG. 5B, the reference plane is a flat plane obtained by averaging heights of the concaves and the convexes in the evaluation area. When the reference plane is a flat plane, a roughness parameter including the swell is calculated. In the example illustrated in FIG. 5C, on the other hand, the reference plane is a curved plane obtained by dividing the evaluation area into a plurality of sub-areas, averaging heights of concaves and convexes in each area, and connecting the averaged heights in the plurality of sub-areas to one another. When the reference plane is a curved plane, a roughness parameter without the swell is calculated.

The evaluation area may be a one-dimensional area, instead. Such an evaluation area is effective for a surface of a target including concaves and convexes distributed in one dimension. The roughness parameter can be, for example, one selected from the group consisting of an arithmetic mean height Ra, a root mean square height Rq, skewness Rsk, kurtosis Rku, and a root-mean-square slope Rdq in a one-dimensional area. When a shape of a one-dimensional area is evaluated, the control circuit 160 may cause the scanning device 130 to perform one-dimensional beam scanning.

### Pre-Measurement

Next, an example of an operation for determining the step angle of the beam scanning on the basis of a result of pre-measurement performed before main measurement will be described.

The pre-measurement is an operation for measuring distances to a plurality of measurement points on a target through beam scanning with a constant step angle. The control circuit 160 may adjust the step angle of the beam scanning in the main measurement performed after the pre-measurement on the basis of a result of the pre-measurement. For example, the control circuit 160 may make the step angle of the beam scanning in the main measurement smaller in areas where the density of measurement points in the pre-measurement is lower.

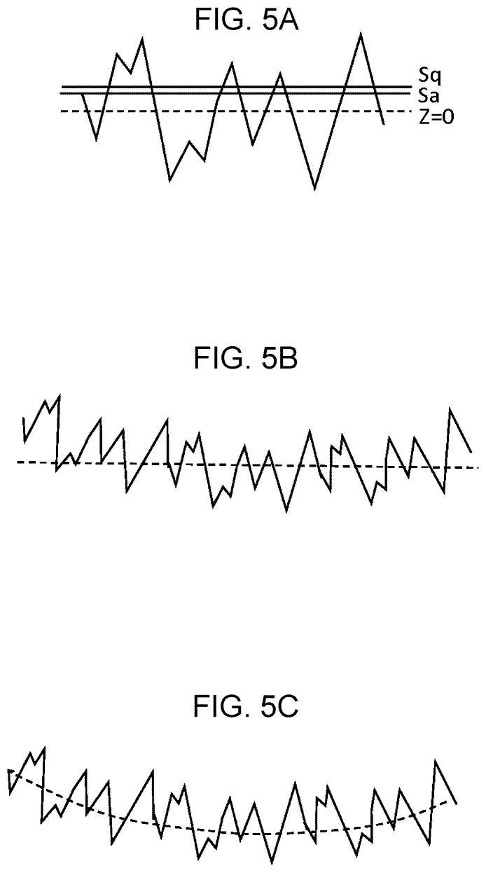

FIG. 6 is a flowchart illustrating an example of a procedure of distance measurement at a time when the pre-measurement is performed. The flowchart of FIG. 6 is different from that of FIG. 4 in that step S111 is added after step S101 and steps S102 and S103 are replaced by steps S112 and S113, respectively. In the example illustrated in FIG. 4, the density of measurement points is corrected using the parameters of the installation angle and the height of the beam emitter 110. In the example illustrated in FIG. 6, on the other hand, the pre-measurement is performed in step S111, and the density of measurement points is corrected in the main measurement on the basis of point cloud data obtained in the pre-measurement. In the pre-measurement, the control circuit 160 measures a distance to each measurement point with, for example, a constant step angle of the beam scanning. As a result, the processing circuit 150 generates point cloud data for the plurality of measurement points. In the next step S112, the processing circuit 150 calculates a distance and a vertical angle between the beam emitter 110 and the measured surface on the basis of the generated point cloud data. These pieces of information are used for the coordinate conversion in the later step S107. In step S113, the control circuit 160 determines the step angle of the beam scanning on the basis of the result of the pre-measurement.

When a target includes a flat surface, the density of measurement points can be appropriately corrected by the method illustrated in FIG. 4. When a surface of a target is not flat, however, the density of measurement points might not be effectively corrected since the angle of incidence of the beam changes depending on a shape of the surface. As in the example illustrated in FIG. 6, therefore, it is effective to perform the pre-measurement, estimate the overall density of measurement points on the basis of point cloud data obtained in the pre-measurement, and determine the step angle of the scanning using a result of the estimation. It is assumed, for example, that the measurement data illustrated in FIG. 3A has been obtained as a result of the pre-measurement. Distribution of the density of measurement points can be estimated from the measurement data. The control circuit 160 determines the step angle of the scanning in advance for each emission direction such that the density distribution becomes uniform in the field of view of the distance measuring apparatus 100, and then performs the 3D measurement on the basis of the step angle. As a result, a shape of a surface of a target can be evaluated more accurately.

With the method illustrated in FIG. 6, when a target includes a known shape such as a flat surface, the parameters of the angles and the height (or the distance) of the beam emitter 110 at the time of the installation can be determined from data obtained in the pre-measurement even if these parameters are unknown or have not been measured. The density of measurement points may be further corrected by correcting the step angle of the scanning using these parameters.

### Plurality of Times of Measurement

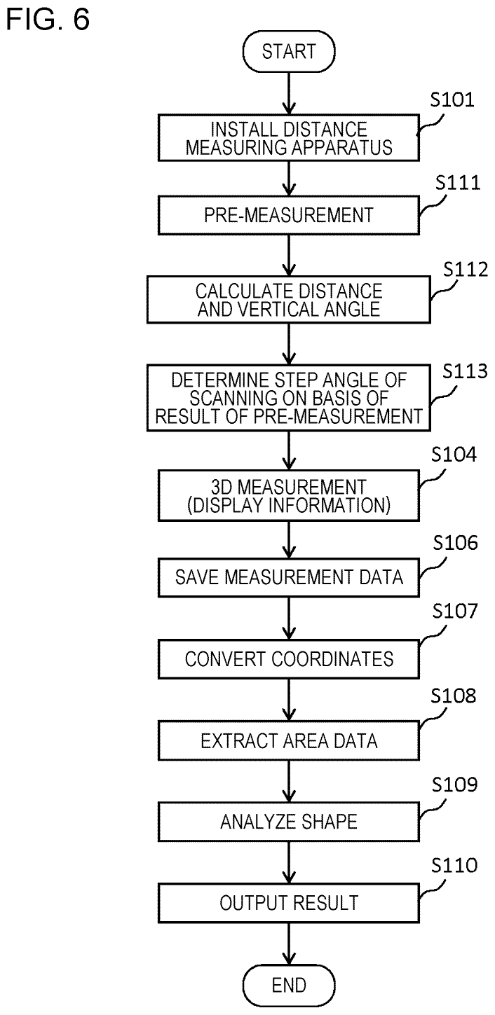

Only a part of an area of a surface that needs to be evaluated can be measured through one-time measurement. In this case, as illustrated in FIG. 7, for example, it is effective to perform measurement a plurality of times while moving the distance measuring apparatus 100. As a result of the measurement performed a plurality of times, the entirety of an area that needs to be evaluated can be measured. For example, the operator may move the distance measuring apparatus 100 or automate the movement using an apparatus for moving the distance measuring apparatus 100.

When the measurement is performed a plurality of times while moving the distance measuring apparatus 100, it might be difficult to appropriately evaluate a surface shape if the density of measurement points varies between different times of measurement. The control circuit 160 may therefore reduce differences in the density of measurement between the different times of measurement by adjusting the step angle of the beam scanning in the different times of measurement. That is, when the distance measuring apparatus 100 measures distances for a first area of a target and, after being moved, measures distances for a second area of the target, the control circuit 160 may adjust the step angle of the beam scanning in the measurement of distances for the second area in such a way as to reduce a difference between the density of measurement points in the first area and the density of measurement points in the second area.

When the distance measuring apparatus 100 is moved, the parameters of the angles or the height of the beam emitter 110 might change in the measurement before and after the movement due to inclination of the installation surface after the movement or presence of concaves and convexes. In this case, too, the angles and the height of the beam emitter 110 can be measured after the installation, and the density of measurement points can be corrected on the basis of these parameters for the measurement. As a result, an effect of making measurement conditions uniform in every time of measurement is produced. The above-described pre-measurement may be performed every time the distance measuring apparatus 100 is moved, and the main measurement may be performed after the density of measurement points is corrected on the basis of the pre-measurement. In this case, too, an effect of equalizing the density of measurement points can be produced.

Method for Equalizing Density of Measurement Points through Data Processing

Next, an example of a method for equalizing the density of measurement points through data processing will be described.

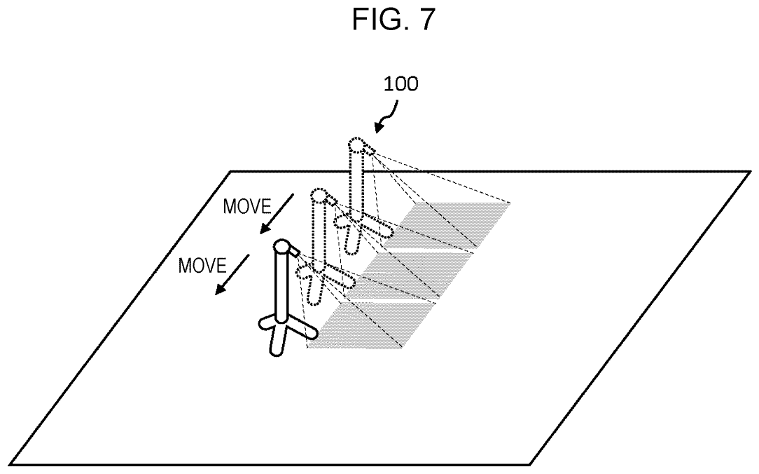

Although differences in the density of measurement points between different areas are reduced by adjusting the step angle of the beam scanning in the above embodiment, the same effect can be produced through data processing. For example, the processing circuit 150 may divide a target area occupied by a plurality of measurement points for which distances have been measured into a plurality of virtual sub-areas (indicated by broken-line frames in FIG. 8) and change the density of measurement points in a subset or all of the sub-areas in such a way as to reduce differences in the density of measurement points between the sub-areas. The density of measurement points can be changed by, for example, removing some measurement points. For example, the processing circuit 150 may reduce differences in the density of measurement points between the plurality of sub-areas by bringing the density of measurement points in at least one of the plurality of sub-areas other than a sub-area where the density of measurement points is the lowest among the plurality of sub-areas close to the density of measurement points in the sub-area where the density of measurement points is the lowest. Furthermore, the processing circuit 150 may reduce differences in the density of measurement points between the plurality of sub-areas by making the density of measurement points in a subset or all of the sub-areas other than a sub-area where the density of measurement points is the lowest among the plurality of sub-areas substantially match the density of measurement points in the sub-area where the density of measurement points is the lowest.

The processing circuit 150 can set the plurality of sub-areas such that, for example, differences in the step angle or area between the sub-areas become small. Alternatively, the user may set the sub-areas as desired. In this case, setting information regarding the plurality of sub-areas can be input from the computer used by the user through the input interface 180. The processing circuit 150 may divide a target area into a plurality of sub-areas in accordance with the information input through the input interface 180. A plurality of sub-areas may be set by combining the above-described methods together. The processing circuit 150 may limit the density of measurement points in each of a plurality of sub-areas to a predetermined density or lower.

The processing circuit 150 may refer to the density of measurement points in each of the plurality of sub-areas and equalize the density of measurement points by removing data for measurement points in sub-areas other than a sub-area where the density of measurement points is the lowest in such a way as to achieve the density of measurement points in the sub-area where the density of measurement points is the lowest. For example, the density of measurement points in sub-areas other than a sub-area where an average distance from the beam emitter 110 to the measurement points is the largest in such a way as to achieve the density of measurement points in the sub-area where the average distance is the largest. The angle of incidence of the beam becomes large for a sub-area far from the beam emitter 110 if a surface of a target is flat.

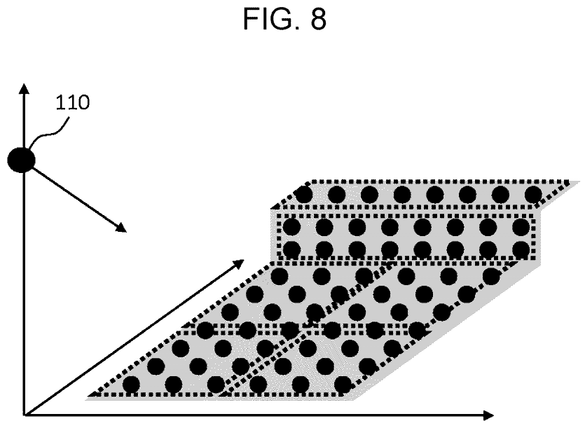

If the density of measurement points in all of the plurality of set sub-areas is higher than a predetermined density necessary to evaluate a surface, data for measurement points may be removed from all of the plurality of sub-areas. The predetermined density necessary to measure a surface can be, for example, the number of measurement points necessary to obtain a surface through fitting based on the measurement points. When a rough surface or a patterned surface is evaluated, for example, a density with which a typical structure size of the surface can be covered by two or more measurement points can be set as the predetermined density. The typical structure size can be, for example, width of a convex or a concave included in a structure, a period of a concave and a convex, height of a convex, or depth of a concave as illustrated in FIG. 9A. Alternatively, the typical structure size can be an average width or an average height of a rough surface as illustrated in FIG. 9B.

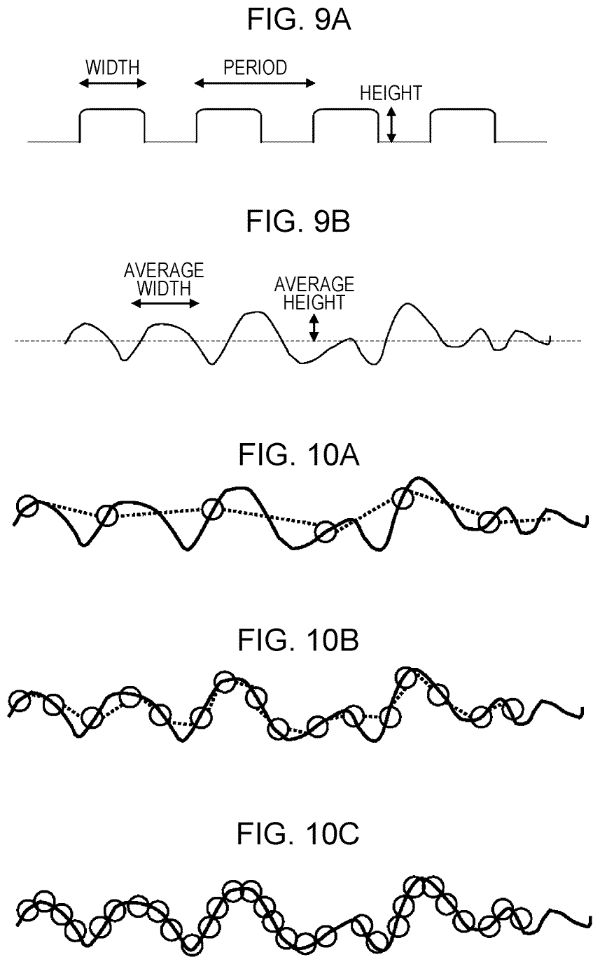

FIG. 10A is a diagram illustrating an example where the density of measurement points is insufficient for structure size. FIG. 10B is a diagram illustrating an example where the density of measurement points is appropriate for structure size. FIG. 10C is a diagram illustrating an example where the density of measurement points is excessive for structure size. In FIGS. 10A to 10C, hollow circles indicate measurement points. When the density of measurement points is too low as illustrated in FIG. 10A, a shape obtained through the 3D measurement deviates from an actual shape, thereby decreasing reliability of evaluation of a structure. When the structure size is covered by two to five measurement points as illustrated in FIG. 10B, a result of the 3D measurement close to true values of a shape can be obtained. When the number of measurement points is too large as illustrated in FIG. 10C, on the other hand, the amount of data to be processed becomes large, which results in a delay in processing. Because the measurement includes noise, a result of the measurement varies around true values. As a result, when results obtained under conditions where the density of measurement points is different are evaluated, results of the evaluation vary. By introducing a process for making the density of measurement points in different sub-areas more uniform as in the present embodiment, variation in results of evaluation can be suppressed, and reliability of the evaluation can be improved.

When a target is made of concrete, for example, the typical structure size can be determined on the basis of size of aggregate included in the concrete. Alternatively, the typical structure size can be estimated through the pre-measurement. The predetermined density can be determined on the basis of information regarding the typical structure size obtained in this manner. For example, the processing circuit 150 may determine the predetermined density on the basis of information regarding a scale (e.g., any of the structure sizes described above) of concaves and convexes on a surface of a target input through the input interface 180. By suppressing the density of measurement points in each sub-area to the predetermined density or lower, a load of arithmetic processing can be reduced while ensuring minimum measurement accuracy required for evaluation of a surface.

The processing circuit 150 may determine a plurality of sub-areas and the predetermined density in the main measurement on the basis of a result of premeasurement where distances to a plurality of measurement points in a target area are measured without changing the density of measurement points. The processing circuit 150 may limit the density of measurement points in each of the plurality of sub-areas in the main measurement to the predetermined density or lower. The processing circuit 150 may thus perform the process for setting sub-areas and reducing differences in the density of measurement points after obtaining a rough overview of a target through the pre-measurement. By performing the process, sub-areas can be appropriately set and differences in density can be reduced even when a target is unknown.

Furthermore, if a necessary density is not achieved in some sub-areas in previous measurement or the pre-measurement, additional measurement may be performed for the sub-areas to add measurement points. That is, the processing circuit 150 may increase the density of measurement points in at least one of a plurality of sub-areas in the main measurement on the basis of a result of the previous measurement or the pre-measurement. By employing this method, the measurement can be completed in a shorter period of time than when the measurement is performed all over again.

The processing circuit 150 may, after measuring distances for a plurality of sub-areas using the above method, extract data regarding an evaluation area, which is a target whose shape is to be analyzed, from obtained data. The shape may then be analyzed from the data as necessary, and a result of the analysis may be output. The shape can be analyzed by, for example, extracting a shape through fitting or using a method for evaluating roughness of a surface. The data can be output by, for example, displaying a result of evaluation of each sub-area on a display device or outputting a result of evaluation of each sub-area as data such as numerical values.

In the above embodiment, the distance measuring apparatus 100 obtains distance data for a plurality of measurement points by performing the beam scanning. A distance measuring apparatus that obtains distance data for a plurality of measurement points using a light source 120 that emits diffuse light, such as a laser or an LED, and an image sensor may be used instead of performing the beam scanning. In this case, the scanning device 130 is not provided. In this distance measuring apparatus, the photodetector 140 includes an image sensor that outputs an image signal as a detection signal. The processing circuit 150 calculates a distance for each of a plurality of pixels in the image signal or each of a plurality of pixel areas in the image signal, and outputs the calculated distances as the distances to the plurality of measurement points. With this configuration, too, the same effect can be produced by performing the process for equalizing the density of measurement points through data processing.

The distance measuring apparatus 100 that performs data processing thus includes the light source 120, the photodetector 140 which receives light reflected from a target irradiated with light from the light source 120 and outputs a detection signal, and the processing circuit 150. The processing circuit 150 calculates a distance to each of a plurality of measurement points included in a target area of the target on the basis of the detection signal and generates measurement data indicating distribution of the distances to, or positions of, the plurality of measurement points. The processing circuit 150 performs, on the measurement data, the process for changing the density of measurement points in at least one of the plurality of sub-areas included in the target area in such a way as to reduce differences in the density of measurement points between the plurality of sub-areas, and outputs the measurement data where the density has been changed. As a result, the density of measurement points in the plurality of sub-areas can be made more uniform, and accuracy of analyzing or evaluating a shape of the target can be improved.

### Checking Operation for Equalizing Density of Measurement Points

A method for checking that a LiDAR sensor (i.e., a distance measuring apparatus) is performing, in 3D measurement, an operation for equalizing the density of measurement points through adjustment of a step angle of scanning or data processing will be described. If the operation for equalizing the density of measurement points is not being performed, the density of measurement points changes in accordance with changes in an angle of a beam radiated when the same measurement target is measured from different angles or different distances. If the operation for equalizing the density of measurement points is being performed, the amount of change in distribution of the density of measurement points within a measurement field of view or between different times of measurement can be suppressed when the same measurement target is measured under different conditions. Whether the distance measuring apparatus is performing the operation for equalizing the density of measurement points can be determined on the basis of the amount of change in distribution of the density of measurement points when measurement is performed under different conditions.

### Determining Whether to Perform Operation for Equalizing Density of Measurement Points

In the system, the user may be enabled to determine whether to perform the operation for equalizing the density of measurement points. When the user can determine whether to perform the operation, for example, data can be obtained without equalizing the density of measurement points. As a result, a case where the equalization has been performed and a case where the equalization has not been performed can be compared, and an appropriate mode can be selected in accordance with a scene.

That is, in the distance measuring apparatus 100 having a function of adjusting the step angle of the beam scanning, the control circuit 160 may be configured to be able to switch between a first mode, where the step angle of the beam scanning is determined in such a way as to reduce differences in the density of measurement points between areas of a target, and a second mode, where the step angle of the beam scanning is constant, in accordance with an operation performed by the user.

In addition, in the distance measuring apparatus 100 having the function of equalizing the density of measurement points through data processing, the processing circuit 150 may be configured to switch between a first mode, where processing for changing the density of measurement points in at least one of a plurality of sub-areas in such a way as to reduce differences in the density of measurement points between the plurality of sub-areas is performed on measurement data, and a second mode, where the processing for changing the density of measurement points is not performed, in accordance with an operation performed by the user.

### Measuring Distances Using FMCW-LiDAR

Next, specific examples of configuration of a LiDAR sensor that measures distances using FMCW, which is an example of the distance measuring apparatus 100, and an operation for measuring distances will be described.

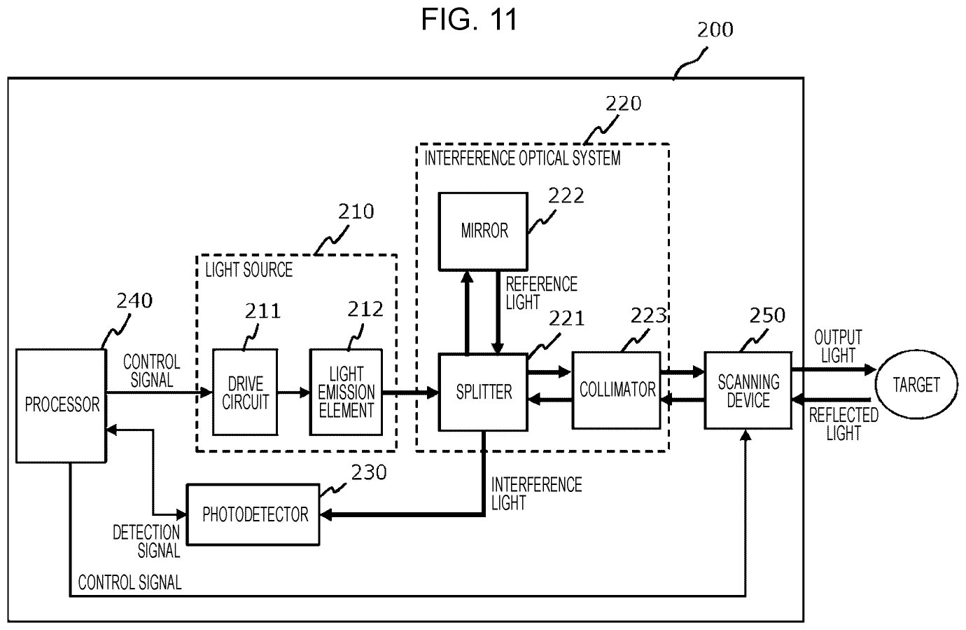

FIG. 11 is a block diagram illustrating an example of configuration of a LiDAR sensor 200, which is an example of the distance measuring apparatus. In FIG. 11, thick arrows indicate a flow of light, and thin arrows indicate a flow of signals or data. FIG. 11 also illustrates a target, for which distances are to be measured. The target can be, for example, an object whose surface includes fine concaves and convexes, such as a concrete surface or a wall.

The LiDAR sensor 200 illustrated in FIG. 11 includes a light source 210, an interference optical system 220, a photodetector 230, a processor 240, and a scanning device 250. In the example illustrated in FIG. 11, the processor 240 has functions of both the processing circuit 150 and the control circuit 160. The light source 210 can change frequency or wavelength of light to be emitted in response to a control signal output from the processor 240. The interference optical system 220 separates light emitted from the light source 210 into reference light and output light and causes reflected light, which is the output light reflected from a target, to interfere with the reference light to generate interference light. The interference light is incident on the photodetector 230.

The photodetector 230 receives the interference light and generates and outputs an electrical signal according to intensity of the interference light. The electrical signal will be referred to as a “detection signal”. The photodetector 230 includes one or more light receiving elements. The light receiving elements include photoelectric conversion elements such as photodiodes. The photodetector 230 may be a sensor in which a plurality of light receiving elements is arranged in two dimensions, such as an image sensor.

The processor 240 controls the light source 210 and performs processing based on a detection signal output from the photodetector 230. The processor 240 functions as a control circuit that controls the light source 210 and the scanning device 250 and a processing circuit that performs signal processing based on the detection signal. The processor 240 may be implemented as a single circuit, or may be an aggregation of a plurality of separate circuits. The processor 240 transmits a control signal to the light source 210. The control signal periodically changes the frequency of light emitted from the light source 210 within a certain range. The processor 240 also transmits a control signal for causing the scanning device 250 to change an emission direction of a light beam. The processor 240 also calculates a distance to each measurement point on the basis of the detection signal output from the photodetector 230.

The light source 210 in this example includes a drive circuit 211 and a light emission element 212. The drive circuit 211 receives a control signal output from the processor 240, generates a drive current signal according to the control signal, and inputs the drive current signal to the light emission element 212. The light emission element 212 can be an element that emits laser light with high coherence, such as a semiconductor laser element. In response to the drive current signal, the light emission element 212 emits laser light whose frequency has been modulated.

The frequency of the laser light emitted from the light emission element 212 is modulated at a certain period. The frequency modulation period can be, for example, 1 microsecond (μs) to 10 milliseconds (ms). Frequency modulation amplitude can be, for example, 100 MHz to 1 THz. Wavelength of the laser light can be included in, for example, a near-infrared wavelength range of 700 nm to 2,000 nm. In solar light, the amount of near-infrared light is smaller than that of visible light. By using near-infrared light as the laser light, therefore, an effect of solar light can be reduced. Depending on a purpose, the wavelength of the laser light may be included in visible light wavelength range of 400 nm to 700 nm or an ultraviolet light wavelength range, instead.

The control signal input from the processor 240 to the drive circuit 211 is a signal whose voltage varies at a certain period by a certain amplitude. The voltage of the control signal can be modulated in the form of, for example, triangular waves or sawtooth waves. Using the control signal whose voltage repeatedly changes linearly like triangular waves or sawtooth waves, the frequency of light emitted from the light emission element 212 can be swept near linearly.

The interference optical system 220 in the example illustrated in FIG. 11 includes a splitter 221, a mirror 222, and a collimator 223. The splitter 221 splits the laser light emitted from the light emission element 212 of the light source 210 into reference light and output light and couples light reflected from a target and the reference light to generate interference light. The mirror 222 reflects the reference light to return the light to the splitter 221. The collimator 223 includes a collimating lens and allows the output light to be radiated onto a target while making spread angles substantially parallel.

The interference optical system 220 is not limited to the configuration illustrated in FIG. 11, and may be, for example, a fiber optical system, instead. In this case, a fiber coupler can be used as the splitter 221. The reference light need not necessarily be reflected by the mirror 222, and, for example, may be returned to the splitter 221 by appropriately routing optical fibers.

The scanning device 250 can include, for example, a MEMS mirror or a galvanometer mirror. The scanning device 250 can change an emission direction of output light by changing an angle of the mirror in accordance with an instruction from the processor 240. As a result, distances can be measured over a wide range through beam scanning. The scanning device 250 is not limited to the above configuration, and may be, for example, a beam scanning device that employs an optical phased array and a slow light waveguide, such as one described in International Publication No. 2019/230720.

Next, measurement of distances by FMCW-LiDAR will be described. The measurement of distances by FMCW-LiDAR is performed on the basis of frequency of interference light caused as a result of interference between reference light subjected to frequency modulation and reflected light.

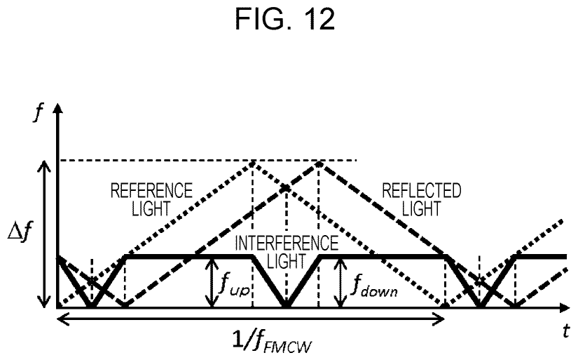

FIG. 12 illustrates an example of temporal changes in frequency of the reference light, the reflected light, and the interference light in a case where a distance between the LiDAR sensor 200 and a target is constant (e.g., both are still). Here, an example will be described where a frequency f of light emitted from the light source 210 changes in the form of triangular waves and a rate of change of frequency in unit time in a period when the frequency increases and a period when the frequency decreases is the same. In the following description, the period when the frequency increases will be referred to as an “up-chirp period”, and the period when the frequency decreases over time will be referred to as a “down-chirp period”. In FIG. 12, a dotted line represents the reference light, a broken line represents the reflected light, and a thick solid line represents the interference light. Compared to the reference light, the light reflected from the target delays in time in accordance with a distance. A constant difference according to the distance, therefore, is caused between the frequency of the reflected light and the frequency of the reference light, except in a period immediately after turning points in the frequency modulation. The interference light has a frequency corresponding to the difference in frequency between the reference light and the reflected light. A frequency fᵤₚ of the interference light in the up-chirp period and a frequency f_{down} of the interference light in the down-chirp period are the same immediately after the turning points in the frequency modulation. The photodetector 230 outputs a detection signal indicating intensity of the interference light. The detection signal will be referred to as a beat signal, and a frequency of the beat signal will be referred to as a beat frequency. The beat frequency is the same as the difference in frequency between the reference light and the reflected light. The difference in frequency depends on the distance from the LiDAR sensor 200 to the target. The distance from the LiDAR sensor 200 to the target, therefore, can be calculated on the basis of the beat frequency.

Here, c denotes the speed of light, f_{FMCW} denotes a modulation frequency of the emitted light, Δf denotes width of the frequency modulation of the emitted light (i.e., a difference between a highest frequency and a lowest frequency), f_{b} denotes the beat frequency (=fᵤₚ=f_{down}), and d denotes the distance from the LiDAR sensor 200 to the target. The modulation frequency f_{FMCW} is a reciprocal of a period of the frequency modulation of the emitted light. The distance d can be calculated on the basis of the following expression (1).

$$d = c \times {f}_{b} / ( Δ f \times {f}_{FMCW} ) \times ( 1 / 4 ) \qquad ( 1 )$$

The processing circuit 150 can generate distance data for a plurality of measurement points by performing the above calculation for the plurality of measurement points. The processing circuit 150 can also convert the distance data for the plurality of measurement points into three-dimensional point cloud data on the basis of information indicating a position and an orientation of a beam emitter of the LiDAR sensor 200.

In FMCW-LiDAR, not only the distances but also speed of the target can be measured. Since the target in the present embodiment is still, however, description of the measurement of speed is omitted.

In the example illustrated in FIG. 11, the processor 240 may change the step angle of the beam scanning performed by the scanning device 250 in accordance with a parameter, such as an angle, of the emitted light. The processor 240 may also suppress variation in the density of measurement points between areas by removing data for some measurement points from the generated three-dimensional point cloud data.

The distance measuring apparatus is not limited to the above LiDAR sensor 200, and may be a sensor that measures distances using ToF, instead. The distance measuring apparatus that employs ToF measures time taken until reflected light is received after light is emitted, and calculates a distance on the basis of the time. The technique in the present disclosure can be applied regardless of a type of distance measuring apparatus.

As described above, a distance measuring apparatus according to an embodiment of the present disclosure includes a light source that emits a light beam, a scanning device that performs beam scanning where an emission direction of the light beam is changed, a photodetector that receives light reflected from measurement points on a target irradiated with the light beam and that outputs detection signals, a processing circuit that calculates distances to the measurement points on a basis of the detection signals, and a control circuit that controls the scanning device. The control circuit determines a step angle of the beam scanning in such a way as to reduce differences in density of the measurement points between areas of the target. As a result, variation in the density of measurement points between the areas can be suppressed, and reliability of evaluation of a surface state based on obtained data can be improved.

The control circuit may change the step angle in accordance with the emission direction of the light beam. For example, the control circuit may reduce the step angle as an angle of incidence of the light beam on the target becomes larger. As a result, a change in the density of measurement points due to a change in the angle of incidence of the light beam on the target can be suppressed.

The control circuit may obtain information indicating a distance between the light source and the target and changes the step angle in accordance with the distance. For example, the control circuit reduces the step angle as the distance becomes larger. As a result, a change in the density of measurement points due to a change in the distance between the light source and the target can be suppressed.

The control circuit may adjust, on a basis of a result of pre-measurement, where the distances to the plurality of measurement points on the target are measured through the beam scanning, the step angle of the beam scanning in main measurement performed after the pre-measurement. As a result, even when a surface of the target is not flat, for example, the overall density of measurement points can be estimated on the basis of data obtained in the pre-measurement. The step angle of the scanning in the main measurement, therefore, can be appropriately determined.

The control circuit may make the step angle of the beam scanning in the main measurement smaller in areas where the density of the measurement points is lower in the pre-measurement. As a result, the differences in the density of measurement points between the areas can be reduced.

The distance measuring apparatus may measure distances for a first area of the target and, after being moved, measure distances for a second area of the target. In this case, the control circuit may adjust the step angle of the beam scanning in the measurement of the distances for the second area in such a way as to reduce a differences between the density of the measurement points in the first area and the density of the measurement points in the second area. As a result, the differences in the density of measurement points between the first area and the second area can be reduced.

The processing circuit may generate and output information indicating roughness of a surface in an area including a plurality of measurement points on the target on a basis of the distance from the distance measuring apparatus to each of the plurality of measurement points. The information indicating roughness of a surface can be, for example, an arithmetic mean height Ra, a root mean square height Rq, skewness Rsk, kurtosis Rku, and a root-mean-square slope Rdq in a one-dimensional area or a two-dimensional area. By generating the information indicating roughness of a surface, a state of the surface of the target can be evaluated.

The control circuit may switch between a first mode, where the step angle of the beam scanning is determined in such a way as to reduce differences in the density of the measurement points between the areas of the target, and a second mode, where the step angle of the beam scanning is constant, in accordance with an operation performed by a user. The user can switch between the first mode and the second mode through, for example, a user interface. As a result, data obtained by performing an operation for reducing differences in the density of measurement points between areas and data obtained without performing the operation can be compared, and the first mode or the second mode can be selected in accordance with a purpose.

A distance measuring apparatus according to another embodiment of the present disclosure includes a light source, a photodetector that receives reflected light from a target irradiated with light from the light source and that outputs a detection signal, and a processing circuit that calculates a distance to each of a plurality of measurement points included in a target area of the target on a basis of the detection signal and that generates measurement data indicating distribution of the distances to, or positions of, the plurality of measurement points. The processing circuit performs, on the measurement data, processing for changing density of the measurement points in at least one of a plurality of sub-areas included in the target area in such a way as to reduce differences in the density of the measurement points between the plurality of sub-areas. As a result, variation in the density of measurement points between the areas can be suppressed, and reliability of evaluation of a surface state based on obtained data can be improved.

The light source may emit a light beam. The distance measuring apparatus may further include a scanning device that performs beam scanning where an emission direction of the light beam is changed. As a result of the beam scanning, information regarding the distance to each of the plurality of measurement points in the target area can be accurately obtained.

The light source may emit diffuse light. The photodetector may include an image sensor that outputs an image signal as the detection signal. The processing circuit may calculate a distance for each of a plurality of pixels in the image signal or each of a plurality of pixel areas in the image signal and output the calculated distances as the distances to the plurality of measurement points. As a result, the information regarding the distance to each of the plurality of measurement points in the target area can be obtained at once.

The distance measuring apparatus may further include an input interface for inputting information for setting the plurality of sub-areas. The processing circuit may divide the target area into the plurality of sub-areas in accordance with the information input through the input interface. As a result, for example, the user can set a plurality of sub-areas as desired.

The processing circuit may reduce the differences in the density of the measurement points between the plurality of sub-areas by bringing the density of the measurement points in at least one of the plurality of sub-areas other than a sub-area where the density of the measurement points is the lowest among the plurality of sub-areas close to the density of the measurement points in the sub-area where the density of the measurement points is the lowest. For example, the processing circuit may bring the density of the measurement points in all of the plurality of sub-areas other than the sub-area whose density is the lowest among the plurality of sub-areas close to or as low as the density of the measurement points in the sub-area whose density is the lowest. As a result of this process, the density of measurement points can be equalized between the sub-areas, and the reliability of the evaluation of a surface shape can be further improved.

The processing circuit may limit the density of the measurement points in each of the plurality of sub-areas to a predetermined density or lower. The predetermined density can be set, for example, to a minimum density required for evaluation of the surface of the target or higher. By suppressing the density of measurement points in each sub-area to the predetermined density or lower, a load of arithmetic processing can be reduced while ensuring minimum measurement accuracy required for the surface evaluation.

The distance measuring apparatus may further include an input interface for inputting information regarding a scale of concaves and convexes on a surface of the target. The processing circuit may change the predetermined density in accordance with the input information. As a result, the user can appropriately set the predetermined density in accordance with the target.

The processing circuit may determine, on a basis of a result of pre-measurement, where the distances to the plurality of measurement points in the target area are measured without changing the density of the measurement points, the plurality of sub-areas in main measurement performed after the pre-measurement. As a result, the plurality of sub-areas can be appropriately determined on the basis of the data obtained in the pre-measurement.

The processing circuit may determine the predetermined density on a basis of the result of the pre-measurement. The density of the measurement points in each of the plurality of sub-areas in the main measurement may be limited to the predetermined density to lower. As a result, the predetermined density can be set to an appropriate value on the basis of the data obtained in the pre-measurement.

The processing circuit may increase the density of the measurement points in at least one of the plurality of sub-areas in the main measurement on a basis of the result of the pre-measurement. As a result, for example, data regarding a sub-area whose density is not high enough to evaluate a surface with only the main measurement can be supplemented with the data obtained in the pre-measurement. Necessary data, therefore, can be obtained with a smaller number of measurement.

The processing circuit may switch between a first mode, where processing for changing the density of the measurement points in at least one of the plurality of sub-areas in such a way as to reduce the differences in the density of the measurement points between the plurality of sub-areas is performed on measurement data, and a second mode, where the processing for changing the density is not performed, in accordance with an operation performed by a user. As a result, data obtained by performing an operation for reducing differences in the density of measurement points between areas and data obtained without performing the operation can be compared, and the first mode or the second mode can be selected in accordance with a purpose.

A method according to yet another embodiment of the present disclosure is a method for controlling a distance measuring apparatus including a light source that emits a light beam, and a scanning device that performs beam scanning where an emission direction of the light beam is changed. The method includes obtaining information regarding the emission direction of the light beam and/or a distance between the target and the light source, determining, on a basis of the information, a step angle of the beam scanning in such a way as to reduce differences in density of measurement points between areas of the target, and performing the beam scanning on a basis of the step angle.

A method according to yet another embodiment of the present disclosure is a method for processing data used by a distance measuring apparatus including a light source and a photodetector that receives light reflected from a target irradiated with light from the light source and that outputs a detection signal. The method includes calculating a distance to each of a plurality of measurement points included in a target area of the target on a basis of the detection signal, generating measurement data indicating distribution of the distances to, or positions of, the plurality of measurement points, and performing, on the measurement data, processing for changing the density of the measurement points in at least one of the sub-areas included in the target area in such a way as to reduce differences in the density of the measurement points between the plurality of sub-areas.

In the above-described embodiment, information indicating roughness of a surface of a target is calculated as an index for evaluating a state of the surface. The index for evaluating a state of a surface, however, is not limited to roughness. When flatness of a surface of a target is to be evaluated, for example, the evaluation index to be calculated may be a grade of the surface.

Alternatively, the evaluation index may be size or a surface area of a target area.

The technique in the present disclosure can be used, for example, for a purpose of performing 3D measurement of a structure such as a building or an industrial product made of a material such as concrete, a metal, wood, or plastic.

What is claimed is:

1. A distance measuring apparatus comprising:
a light source that emits a light beam;
a scanning device that performs beam scanning where an emission direction of the light beam is changed;
a photodetector that receives light reflected from measurement points on a target irradiated with the light beam and that outputs detection signals;
a processing circuit that calculates distances to the measurement points on a basis of the detection signals; and
a control circuit that controls the scanning device,
wherein the control circuit determines a step angle of the beam scanning in such a way as to reduce differences in density of the measurement points between areas of the target.

2. The distance measuring apparatus according to claim 1,
wherein the control circuit changes the step angle in accordance with the emission direction of the light beam.

3. The distance measuring apparatus according to claim 2,
wherein the control circuit reduces the step angle as an angle of incidence of the light beam on the target becomes larger.

4. The distance measuring apparatus according to claim 1,
wherein the control circuit obtains information indicating a distance between the light source and the target and changes the step angle in accordance with the distance.

5. The distance measuring apparatus according to claim 4,
wherein the control circuit reduces the step angle as the distance becomes larger.

6. The distance measuring apparatus according to claim 1,
wherein the control circuit adjusts, on a basis of a result of pre-measurement, where the distances to the plurality of measurement points on the target are measured through the beam scanning, the step angle of the beam scanning in main measurement performed after the pre-measurement.

7. The distance measuring apparatus according to claim 6,
wherein the control circuit makes the step angle of the beam scanning in the main measurement smaller in areas where the density of the measurement points is lower in the pre-measurement.

8. The distance measuring apparatus according to claim 1,
wherein, after performing distance measurement for a first area of the target using the distance measuring apparatus, when the distance measuring apparatus is moved to perform distance measurement for a second area of the target, the control circuit adjusts the step angle of the beam scanning in the measurement of the distances for the second area in such a way as to reduce a differences between the density of the measurement points in the first area and the density of the measurement points in the second area.

9. The distance measuring apparatus according to claim 1,
wherein the processing circuit generates and outputs information indicating roughness of a surface in an area including a plurality of measurement points on the target on a basis of the distance from the distance measuring apparatus to each of the plurality of measurement points.

10. The distance measuring apparatus according to claim 1,
wherein the processing circuit generates and outputs information indicating flatness of a surface in an area including a plurality of measurement points on the target on a basis of the distance from the distance measuring apparatus to each of the plurality of measurement points.

11. The distance measuring apparatus according to claim 1,
wherein the control circuit switches between a first mode, where the step angle of the beam scanning is determined in such a way as to reduce differences in the density of the measurement points between the areas of the target, and a second mode, where the step angle of the beam scanning is constant, in accordance with an operation performed by a user.

12. A distance measuring apparatus comprising:
a light source;
a photodetector that receives reflected light from a target irradiated with light from the light source and that outputs a detection signal; and
a processing circuit that calculates a distance to each of a plurality of measurement points included in a target area of the target on a basis of the detection signal and that generates measurement data indicating distribution of the distances to, or positions of, the plurality of measurement points,
wherein the processing circuit performs, on the measurement data, processing for changing density of the measurement points in at least one of a plurality of sub-areas included in the target area in such a way as to reduce differences in the density of the measurement points between the plurality of sub-areas.

13. The distance measuring apparatus according to claim 12,
wherein the light source emits a light beam,
the distance measuring apparatus further comprising:
a scanning device that performs beam scanning where an emission direction of the light beam is changed.

14. The distance measuring apparatus according to claim 12,
wherein the light source emits diffuse light,
wherein the photodetector includes an image sensor that outputs an image signal as the detection signal, and
wherein the processing circuit calculates a distance for each of a plurality of pixels in the image signal or each of a plurality of pixel areas in the image signal and outputs the calculated distances as the distances to the plurality of measurement points.

15. The distance measuring apparatus according to claim 12, further comprising:
an input interface for inputting information for setting the plurality of sub-areas,
wherein the processing circuit divides the target area into the plurality of sub-areas in accordance with the information input through the input interface.

16. The distance measuring apparatus according to claim 12,
wherein the processing circuit reduces the differences in the density of the measurement points between the plurality of sub-areas by bringing the density of the measurement points in at least one of the plurality of sub-areas other than a sub-area where the density of the measurement points is the lowest among the plurality of sub-areas close to the density of the measurement points in the sub-area where the density of the measurement points is the lowest.

17. The distance measuring apparatus according to claim 12,
wherein the processing circuit limits the density of the measurement points in each of the plurality of sub-areas to a predetermined density or lower.

18. The distance measuring apparatus according to claim 17,
wherein the processing circuit obtains information regarding a scale of concaves and convexes on a surface of the target and changes the predetermined density in accordance with the obtained information.

19. The distance measuring apparatus according to claim 12,
wherein the processing circuit determines, on a basis of a result of pre-measurement, where the distances to the plurality of measurement points in the target area are measured without changing the density of the measurement points, the plurality of sub-areas in main measurement performed after the pre-measurement.

20. The distance measuring apparatus according to claim 19,
wherein the processing circuit determines the predetermined density on a basis of the result of the pre-measurement, and
wherein the density of the measurement points in each of the plurality of sub-areas in the main measurement is limited to the predetermined density to lower.

21. The distance measuring apparatus according to claim 19,
wherein the processing circuit increases the density of the measurement points in at least one of the plurality of sub-areas in the main measurement on a basis of the result of the pre-measurement.

22. The distance measuring apparatus according to claim 12,
wherein the processing circuit switches between a first mode, where processing for changing the density of the measurement points in at least one of the plurality of sub-areas in such a way as to reduce the differences in the density of the measurement points between the plurality of sub-areas is performed on measurement data, and a second mode, where the processing for changing the density is not performed, in accordance with an operation performed by a user.

23. A method for controlling a distance measuring apparatus including a light source that emits a light beam, and a scanning device that performs beam scanning where an emission direction of the light beam is changed, the method comprising:
obtaining information regarding the emission direction of the light beam and/or a distance between the target and the light source;
determining, on a basis of the information, a step angle of the beam scanning in such a way as to reduce differences in density of measurement points between areas of the target; and
performing the beam scanning on a basis of the step angle.

24. A method for processing data used by a distance measuring apparatus including a light source and a photodetector that receives light reflected from a target irradiated with light from the light source and that outputs a detection signal, the method comprising:
calculating a distance to each of a plurality of measurement points included in a target area of the target on a basis of the detection signal;
generating measurement data indicating distribution of the distances to, or positions of, the plurality of measurement points; and
performing, on the measurement data, processing for changing the density of the measurement points in at least one of the sub-areas included in the target area in such a way as to reduce differences in the density of the measurement points between the plurality of sub-areas.
